(19) United States
(12) Patent Application Publication
(10) Pub. No.: US 2026/0160035 A1
(43) Pub. Date: Jun. 11, 2026

(54) Dissolvable Snow and Ice Melting Device

(71) Applicants: Henrietta Reese, Philadelphia, PA (US); Junious Samuels, Philadelphia, PA (US)

(72) Inventors: Henrietta Reese, Philadelphia, PA (US); Junious Samuels, Philadelphia, PA (US)

(21) Appl. No.: 19/414,975

(22) Filed: Dec. 10, 2025

Related U.S. Application Data
(60) Provisional application No. 63/730,155, filed on Dec. 10, 2024.

(51) Int. Cl. E01H 5/12; B32B 3/26; B32B 3/30; B32B 5/16

(52) U.S. Cl. CPC E01H 5/12; B32B 3/263; B32B 3/30; B32B 5/16; B32B 2250/03; B32B 2250/40; B32B 2264/104; B32B 2307/7166

(57) ABSTRACT

A dissolvable snow and ice melting device is provided. The device is comprised of a dissolvable device configured for placement over snow- or ice-covered outdoor areas. The device comprises a multilayered body including a top layer, a bottom layer, and a dissolvable binding layer positioned between the top and bottom layers. The top and bottom layers comprise compressed particulate de-icing material. The binding layer comprises a water-reactive matrix designed to degrade upon contact with meltwater. Upon deployment, the bottom layer initiates melting of the snow or ice, triggering the dissolution of the binding layer and the release of embedded agents, while the top layer maintains structural support and further prevents the accumulation of snow or the formation of ice.

### CROSS-REFERENCE TO RELATED APPLICATION

The present application claims priority to, and the benefit of, U.S. Provisional Application No. 63/730,155, which was filed on Dec. 10, 2024, and is incorporated herein by reference in its entirety.

### FIELD OF THE INVENTION

The present invention relates generally to the field of snow and ice melting devices. More specifically, the present invention relates to a multilayered device that can be placed over snow-or ice-covered surfaces, comprised of de-icing materials in the top and bottom layers melt that melt accumulate while a water-reactive binding layer dissolves upon contact with moisture. Accordingly, the present disclosure makes specific reference thereto. Nonetheless, it is to be appreciated that aspects of the present invention are also equally applicable to other like applications, devices, and methods of manufacture.

### BACKGROUND

In areas where snow and ice are regular occurrences, maintaining clear and safe outdoor surfaces such as sidewalks, driveways, and walkways presents a significant burden. Accumulated snow and ice not only impede mobility but also contribute to safety hazards, including slips, falls, and vehicular accidents. The conventional solutions available to address these issues, such as shovels, snow blowers, and snowplows, demand extensive manual labor, involve high operating costs, or require fossil fuel consumption. Additionally, these methods primarily displace the snow rather than eliminate it, leaving residual ice that can refreeze and perpetuate the hazard. While chemical deicers and salt can assist in melting, their application is often uneven and requires repeated manual effort, especially after ongoing precipitation. Furthermore, these substances may corrode concrete, damage vegetation, or contaminate groundwater due to runoff. These environmental and practical limitations underscore the inefficiencies of current snow and ice removal techniques. A passive, reliable, and low-maintenance alternative that can efficiently melt snow and ice while minimizing human involvement and environmental impact remains necessary to address this longstanding challenge in cold-weather environments.

Therefore, there exists a long-felt need in the art for a dissolvable snow and ice melting device that provides a self-contained and effective means for melting snow and ice directly on various surfaces. There also exists a long-felt need in the art for a dissolvable snow and ice melting device that minimizes the need for manual tools or mechanical snow removal equipment. Moreover, there exists a long-felt need in the art for a dissolvable snow and ice melting device that ensures surface stability and safety throughout the melting process.

The subject matter disclosed and claimed herein, in one embodiment thereof, comprises a dissolvable snow and ice melting device. The device is comprised of a dissolvable device configured for placement over snow- or ice-covered outdoor areas including but not limited to driveways, walkways, sidewalks, patios, landings, and loading zones. The device comprises a multilayered body including a top layer, a bottom layer, and a dissolvable binding layer positioned between the top and bottom layers. The top and bottom layers comprise compressed particulate de-icing material. The binding layer comprises a water-reactive matrix designed to degrade upon contact with meltwater. Various layers of the device may be textured to enhance friction and slip resistance, while embedded additives such as corrosion inhibitors, traction enhancers, and visible colorants may be dispersed throughout the de-icing layers. Perforations or score lines may be included to allow for selective resizing or flexibility across irregular surfaces. Upon deployment, the bottom layer initiates melting of the snow or ice, triggering the dissolution of the binding layer and the release of embedded agents, while the top layer maintains structural support and further prevents the accumulation of snow or the formation of ice.

In this manner, the dissolvable snow and ice melting device of the present invention accomplishes all the foregoing objectives and provides a layered, moisture-reactive device that passively melts snow and ice without requiring active labor or mechanical equipment. More specifically, the use of compressed de-icing compounds and a dissolvable binder ensures consistent melting performance while minimizing residue and environmental impact. Embedded additives may further enhance surface safety, reduce corrosion, and improve visibility during use. During use, the device dissolves progressively as the melting cycle proceeds, ultimately leaving no significant waste or requiring post-use cleanup. Therefore, the invention offers a practical, low-maintenance solution to persistent snow and ice removal challenges, improving safety and efficiency in winter weather conditions.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dissolvable snow and ice melting device. The device is configured for placement over outdoor surfaces to deliver de-icing material to said surfaces while also providing a stable surface for foot or vehicle traffic during the melting process. This configuration enables accelerated ice breakdown and reduces reliance on manual or fuel-based snow and ice removal methods.

The device is comprised of a multilayered body that may take various geometric forms, including sheets, pads, tiles, or modular segments. The body comprises a bottom layer, a top layer, and an intermediate dissolvable binding layer between the bottom and top layers. The top and bottom layers are each comprised of a compressed matrix of particulate de-icing material. The dissolvable binding layer is comprised of a water-reactive matrix designed to maintain structural integrity during storage and dissolve gradually upon moisture exposure. This layer may include a textured surface formed by molding or printing to improve traction and water drainage. Additives may be incorporated into the de-icing material or binding layer to enhance corrosion resistance, traction, or visibility. These additives may include inhibitors, traction granules, or colorants.

During use, the device is deployed over snow or ice, where the bottom layer initiates melting of the same. Meltwater then dissolves the binding layer, releasing any embedded additives and causing structural breakdown. The top layer may remain longer to sustain surface stability and resist further accumulation. The body then ultimately dissolves or disintegrates into environmentally degradable residues.

Accordingly, the dissolvable snow and ice melting device of the present invention is particularly advantageous as it provides a layered, moisture-reactive device that passively melts snow and ice without requiring active labor or mechanical equipment. More specifically, the use of compressed de-icing compounds and a dissolvable binder ensures consistent melting performance while minimizing residue and environmental impact. Embedded additives may further enhance surface safety, reduce corrosion, and improve visibility during use. During use, the device dissolves progressively as the melting cycle proceeds, ultimately leaving no significant waste or requiring post-use cleanup. Therefore, the invention offers a practical, low-maintenance solution that overcomes existing snow and ice removal challenges with existing devices and methods, thus improving safety and efficiency in winter weather conditions.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dissolvable snow and ice melting device of the present invention in accordance with the disclosed architecture;

FIG. 2 illustrates an exploded perspective view of one potential embodiment of a dissolvable snow and ice melting device of the present invention in accordance with the disclosed architecture;

FIG. 3 illustrates a top and bottom view of one potential embodiment of a dissolvable snow and ice melting device of the present invention in accordance with the disclosed architecture; and

FIG. 4 illustrates a flowchart of a method of using one potential embodiment of a dissolvable snow and ice melting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a dissolvable snow and ice melting device that provides a self-contained and effective means for melting snow and ice directly on various surfaces. There also exists a long-felt need in the art for a dissolvable snow and ice melting device that minimizes the need for manual tools or mechanical snow removal equipment. Moreover, there exists a long-felt need in the art for a dissolvable snow and ice melting device that ensures surface stability and safety throughout the melting process.

The present invention, in one exemplary embodiment, is comprised of a dissolvable snow and ice melting device. The device is designed for deployment over outdoor surfaces to apply de-icing material directly to said surfaces, while simultaneously providing a stable platform for pedestrian or vehicular traffic throughout the melting process. By enabling faster ice breakdown, the device reduces dependence on manual or fuel-powered snow and ice removal techniques.

The device is comprised of a multilayered body formed in various geometric configurations, such as sheets, pads, tiles, or modular segments. The body includes a bottom layer, a top layer, and a dissolvable binding layer positioned between them. Both the top and bottom layers are comprised of a compressed matrix of particulate de-icing material. The intermediate binding layer is comprised of a water-reactive matrix that retains structural integrity in storage and gradually dissolves when exposed to moisture. The binding layer may also include molded or printed texturing to enhance traction and facilitate water drainage. Additives may be included within the de-icing layers or the binding layer to improve corrosion resistance, surface grip, or visual contrast, using components such as corrosion inhibitors, traction-enhancing granules, or colorants.

In operation, the device is laid onto snow-or ice-covered surfaces, where the bottom layer activates melting. The resulting meltwater dissolves the intermediate binding layer, which releases any embedded additives and leads to structural disintegration. The top layer may remain intact longer to preserve surface stability and reduce further accumulation. Ultimately, the body fully dissolves or breaks down into environmentally degradable residues.

As a result, the device passively eliminates snow and ice without manual effort or mechanical intervention. The integration of compressed de-icing materials with a dissolvable binder ensures effective melting performance and limits environmental residue. Embedded additives may further enhance surface safety, visibility, and material preservation during use. As the melting process advances, the body gradually degrades, eliminating the need for post-use cleanup. As such, the device delivers a practical, low-maintenance alternative to conventional snow and ice removal methods, improving both safety and operational efficiency under winter conditions.

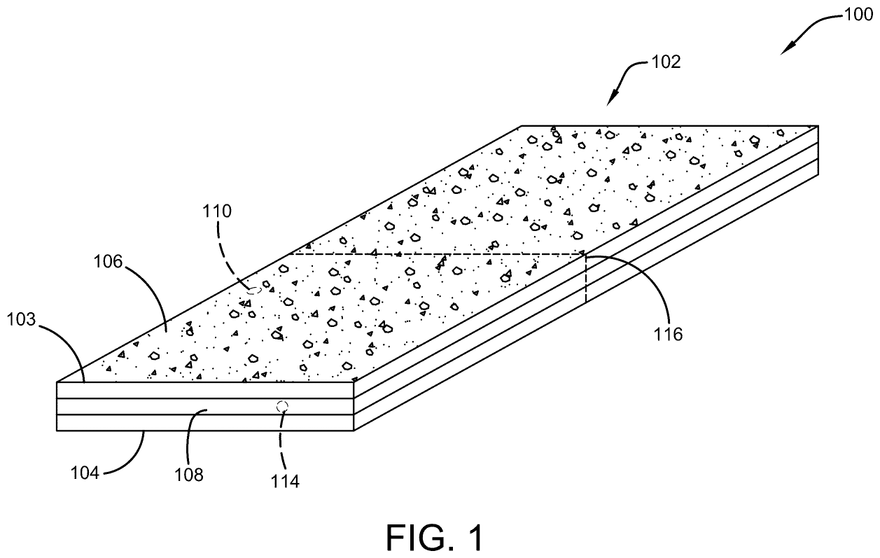

Referring initially to the drawings, FIG. 1 illustrates a perspective view of one potential embodiment of a dissolvable snow and ice melting device 100 of the present invention in accordance with the disclosed architecture. The device 100 is a deployable snow-and ice-removal device configured for placement over outdoor surfaces such as but not limited to driveways, sidewalks, walkways, entry paths, stair landings, patios, and loading zones. The device 100 functions by delivering de-icing material 110 directly onto snow-or ice-covered surfaces while concurrently offering a physically stable surface suitable for pedestrian or vehicular travel during the melting process. As a result, the device 100 facilitates rapid ice breakdown and reduces reliance on labor-intensive or fuel-dependent snow removal methods such as shoveling, plowing, or snow blowing.

The device 100 is comprised of a multilayered body 102 that is deployable over a snow-or ice-covered substrate. The body 102 may be made in various geometric configurations such as but not limited to rectangular sheets, circular pads, hexagonal tiles, elongated strips, modular interlocking segments, or custom contoured forms designed to conform to architectural or topographical constraints. The body 102 may vary in thickness depending on performance criteria, deployment method, or load-bearing requirements. Edges 103 of the body 102 may be beveled, chamfered, or tapered to minimize tripping hazards and improve adhesion to irregular ground contours.

The body 102 is further comprised of a bottom layer 104, a top layer 106, and a dissolvable binding layer 108 positioned between and connecting the bottom layer 104 and top layer 106, as seen in FIG. 1. The bottom layer 104 and top layer 106 may each be comprised of a compressed matrix of particulate de-icing material 110. The de-icing material 110 may be comprised of chemical agents such as but not limited to sodium chloride, calcium chloride, magnesium chloride, potassium acetate, urea-based compounds, ammonium-based salts, or any blend or layered arrangement thereof. The material 110 may be processed into granulated, flaked, spherical, crystalline, rod-like, liquid coatings, or pelletized forms.

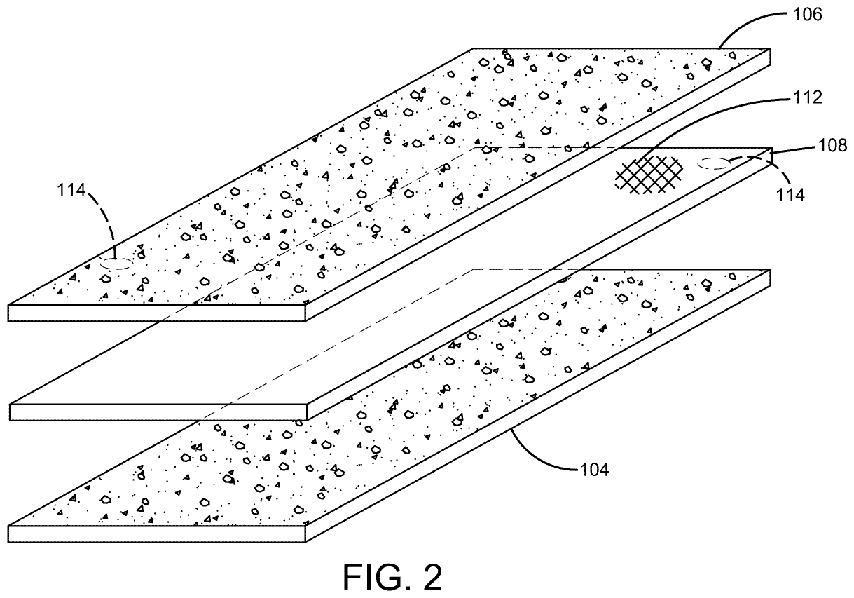

The dissolvable binding layer 108 may be comprised of a water-reactive matrix configured to provide structural integrity in dry storage and gradual disintegration upon exposure to meltwater or ambient moisture. The layer 108 may be comprised of materials such as but not limited to starch-based biopolymers, cellulose-based composites, water-soluble polyvinyl alcohol films, salt-infused biodegradable binders, thermoplastic starches, polyacrylic acids, or mixtures thereof. In one embodiment, the binding layer 108 may further be comprised of a texture 112 formed by embossing, extrusion molding, or surface printing, as seen in FIG. 2. The texture 112 may include geometries such as but not limited to raised grids, parallel ribs, radial patterns, or raised or recessed projections, which may improve friction, water channeling, and slip resistance.

In one embodiment, the body 102 may be further comprised of perforations or score lines 116 extending through one or more of the layers 104, 106,108 as seen in FIG. 1. The perforations 116 may be arranged in regular or irregular grids, radial arrays, zigzag paths, or segmental outlines, enabling the user to selectively tear, fold, or resize the body 102. The perforations/score lines 116 may also serve as mechanical strain relief zones, allowing limited flexing or deformation of the sheet in response to terrain undulations.

The particulate de-icing material 110 and/or the binding layer 108 may be further comprised of an additive 114 (as seen in FIG. 2) configured to improve environmental, physical, or operational performance. The additive 114 may be comprised of corrosion inhibitors configured to reduce degradation of adjacent concrete, metal fixtures, or vegetation. The additive 114 may alternatively or additionally be comprised of granular traction agents such as but not limited to crushed stone, volcanic ash, sand, ground nut shells, diatomaceous earth, fine gravel, or pumice to further improve grip. The additive 114 may also be comprised of colorants such as but not limited to non-toxic, UV-stable, water-soluble dyes or pigments. The colorants may serve to increase device 100 visibility.

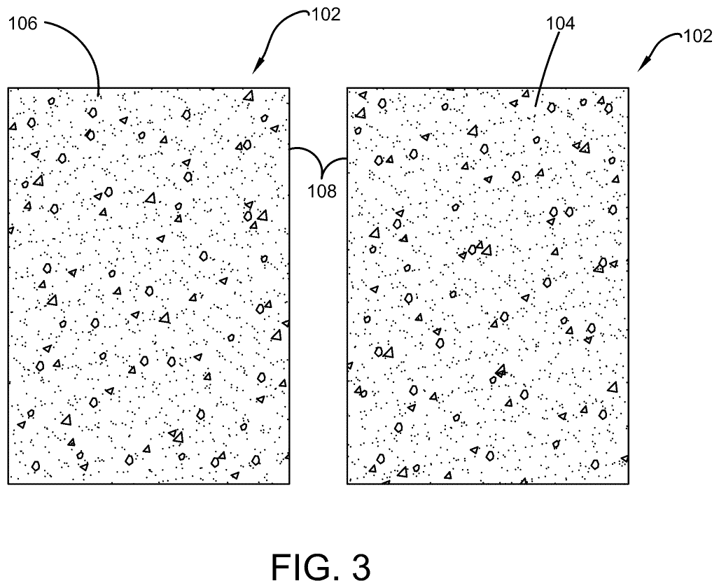

The particulate material 110 of the layers 104, 106 may be partially embedded or pressure-fused into the dissolvable binder 108 in one embodiment to improve mechanical integrity and ensure simultaneous dissolution, as seen in FIG. 3. The top layer 106 and bottom layer 104 may be symmetric or may be comprised of differing material compositions to provide tiered melting action, surface reinforcement, or extended performance under snowfall. In one variation, the upper layer 106 may feature a slower-dissolving composition or a coarser particle structure than the bottom layer 104 to maintain surface friction over an extended period.

In operation, the device 100 may be unrolled, unfolded, or otherwise placed directly onto a snow-or ice-covered surface, wherein the de-icing material 110 in the bottom layer 104 may initiate melting through a primarily exothermic dissolution upon contact with snow and ice. The resulting meltwater may begin dissolving the binding layer 108, thus releasing any embedded additives 114 and destabilizing the structural matrix of the body 102. As the material 110 continues to react with snow and moisture, the body 102 may gradually lose cohesion and disperse into the underlying surface. The top layer 106 may further remain intact for a longer duration in one embodiment to mitigate further accumulation, absorb new precipitation, and maintain anti-slip surface properties. Following the completion of the melting cycle, the body 102 may dissolve entirely or fragment into residues that may be swept away, washed into drainage systems, or left to naturally degrade.

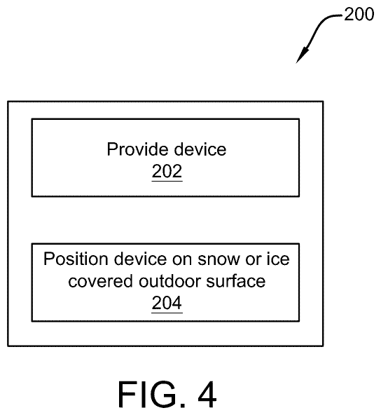

The present invention is also comprised of a method of using 200 the device 100, as seen in FIG. 4. First, a device 100 is provided comprised of a body 102 comprised of a bottom layer 104, a top layer 106, and a dissolvable binding layer 108 positioned between the bottom layer 104 and top layer 106, wherein the bottom layer 104 and top layer 106 are each comprised of a compressed matrix of particulate de-icing material 110 [Step 202]. Then, the device 100 is positioned directly onto a snow-or ice-covered outdoor surface such as but not limited to a driveway, walkway, entry path, or stair landing [Step 204]. The particulate de-icing material 110 of the bottom layer 104 then initiates melting upon contact with the snow or ice, causing meltwater to interact with and begin dissolving the binding layer 108. Then, as the binding layer 108 dissolves, embedded additives 114 (if present) are released and the structural cohesion of the body 102 is progressively destabilized. Next, the body 102 continues to dissolve or fragment due to sustained moisture exposure, while the top layer 106 may remain temporarily intact to provide surface stability, precipitation absorption, and slip resistance. Finally, upon completion of the melting cycle, the body 102 fully dissolves or disintegrates into residues that may be left to degrade naturally or removed by sweeping or rinsing.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dissolvable snow and ice melting device” and “device” are interchangeable and refer to the dissolvable snow and ice melting device 100 of the present invention.

Notwithstanding the foregoing, the dissolvable snow and ice melting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dissolvable snow and ice melting device 100 as shown in the FIGS. are for illustrative purposes only, and that many other sizes and shapes of the dissolvable snow and ice melting device 100 are well within the scope of the present disclosure. Although the dimensions of the dissolvable snow and ice melting device 100 are important design parameters for user convenience, the dissolvable snow and ice melting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dissolvable snow and ice melting device comprising:
a body comprising a bottom layer, a top layer, and a dissolvable binding layer positioned between and connecting the bottom layer and the top layer, wherein the bottom layer and the top layer are each comprised of a particulate de-icing material.

2. The dissolvable snow and ice melting device of claim 1, wherein the body is comprised of a beveled edge, a chamfered edge, or a tapered edge.

3. The dissolvable snow and ice melting device of claim 1, wherein the particulate de-icing material is comprised of a sodium chloride, a calcium chloride, a magnesium chloride, a potassium acetate, a urea-based compounds, or an ammonium-based salts.

4. The dissolvable snow and ice melting device of claim 1, wherein the particulate de-icing material is granulated, flaked, spherical, crystalline, or pelletized.

5. The dissolvable snow and ice melting device of claim 1, wherein the particulate de-icing material is a liquid coating.

6. The dissolvable snow and ice melting device of claim 1, wherein the binding layer is comprised of a texture.

7. The dissolvable snow and ice melting device of claim 6, wherein the texture is comprised of a grid, a rib, a radial pattern, a raised projection, or a recessed projection.

8. The dissolvable snow and ice melting device of claim 1 further comprised of an additive.

9. The dissolvable snow and ice melting device of claim 8, wherein the additive is comprised of a crushed stone, a volcanic ash, a sand, a ground nut shell, a diatomaceous earth, a fine gravel, or a pumice.

10. The dissolvable snow and ice melting device of claim 8, wherein the additive is comprised of a dye or a pigment.

11. The dissolvable snow and ice melting device of claim 1, wherein the particulate de-icing material is embedded into the binding layer.

12. A dissolvable snow and ice melting device comprising:
a body comprising a perforation, a bottom layer, a top layer, and a dissolvable binding layer positioned between and connecting the bottom layer and the top layer, wherein the bottom layer and the top layer are each comprised of a particulate de-icing material.

13. The dissolvable snow and ice melting device of claim 12, wherein the particulate de-icing material is comprised of a sodium chloride, a calcium chloride, a magnesium chloride, a potassium acetate, a urea-based compounds, or an ammonium-based salts.

14. The dissolvable snow and ice melting device of claim 12, wherein the particulate de-icing material is granulated, flaked, spherical, crystalline, or pelletized.

15. The dissolvable snow and ice melting device of claim 12, wherein the binding layer is comprised of a texture.

16. The dissolvable snow and ice melting device of claim 15, wherein the texture is comprised of a grid, a rib, a radial pattern, a raised projection, or a recessed projection.

17. The dissolvable snow and ice melting device of claim 12 further comprised of an additive.

18. The dissolvable snow and ice melting device of claim 17, wherein the additive is comprised of a crushed stone, a volcanic ash, a sand, a ground nut shell, a diatomaceous earth, a fine gravel, or a pumice.

19. The dissolvable snow and ice melting device of claim 17, wherein the additive is comprised of a dye or a pigment.

20. A method of using a dissolvable snow and ice melting device, the method comprising the following steps:
providing a dissolvable snow and ice melting device comprised of a body comprising a bottom layer, a top layer, and a dissolvable binding layer positioned between the bottom layer and the top layer, wherein the bottom layer and the top layer are each comprised of a compressed matrix of particulate de-icing material; and
placing the device onto a snow-or ice-covered outdoor surface.
